(19) United States
(12) Patent Application Publication
(10) Pub. No.: US 2011/0315164 A1
(43) Pub. Date: Dec. 29, 2011

(54) Method and apparatus for cleaning vessels

(75) Inventor: Kenny DesOrmeaux, Abbeville, LA (US)

(73) Assignee: OCS Technologies, L.L.C., Abbeville, LA (US)

(21) Appl. No.: 13/135,018

(22) Filed: Jun. 23, 2011

Related U.S. Application Data
(60) Provisional application No. 61/357,802, filed on Jun. 23, 2010.

(51) Int. Cl. B08B 9/035

(52) U.S. Cl. 134/21; 15/300.1

(57) ABSTRACT

The present invention includes apparatuses, systems, and methods for the safe and efficient removal of materials from tanks. An apparatus is provided that includes a chassis and a remotely controllable articulating vacuum assembly attached to the chassis. The vacuum assembly has at least two joints and is configured to remove material from an interior portion of the vessel.

### CROSS-REFERENCE TO RELATED APPLICATIONS

This application claims the benefit of U.S. Provisional Patent Application Ser. No. 61/357,802 filed on Jun. 23, 2010, which is expressly incorporated herein in its entirety by reference hereto.

### FIELD

The present invention relates to methods and apparatuses for the removal materials from tanks or vessels, and in a particular though non-limiting embodiment, to machines and methods for removing solids, fluids, slurries, and sludge from the interior of a tank or other vessel.

### BACKGROUND

Conventional tank cleaning is often a long, stringent, hazardous and labor-intensive task. Conventional methods of tank and vessel cleaning require human exposure to dangerous environments.

Most currently available remote tank cleaning systems and associated methods include one or more nozzles configured to direct a fluid stream to dislodge, dilute, or dissolve settled solids from tank interiors. Generally, the purpose of these systems is to “fluidize” the settled solids and/or sludge to an extent that it can be easily pumped out. However, in some instances, settled solids and/or sludge inside tanks or other vessels cannot be removed, dissolved, or otherwise “fluidized” by the aforementioned conventionally available systems due to the composition of the solids, conditions inside the tank, etc. In such situations, the solids and/or sludge must be physically/mechanically removed from the tank interior. Such methods may be time-consuming and may require one or more workers to physically enter the tank or vessel to mechanically dislodge the solids/sludge—a process that may place such workers in a dangerous and/or toxic environment and therefore at greater risk of exposure to health hazards and injuries. Furthermore, depending on the material needing removal, multiple tools and systems may be required, forcing the work to be stopped and restarted while the equipment is changed out. Additionally, often times the cleaning equipment is too large to fit through the vessel's access point, requiring further operator exposure inside of the vessel in order to assemble the equipment parts.

Therefore, there is a long-felt, but unmet, need for a remote and/or automated apparatus and method for the removal of materials, including settled solids, fluids, slurries, or sludge, from a tank interior in order to increase the efficiency of such removal and to protect human workers from health risks and injuries.

### SUMMARY

Example embodiments of the present invention include apparatuses, systems, and methods for the safe and efficient removal of materials from tanks. According to an exemplary embodiment of the present invention, an apparatus is provided for removing material from a vessel. The apparatus includes a chassis and a remotely controllable articulating vacuum assembly attached to the chassis. The vacuum assembly may include two joints and be configured to remove material from an interior portion of a vessel. The vacuum assembly may include an arm having a first end pivotally connected to the chassis and a second end pivotally connected to a vacuum boom.

Example embodiments of the present invention are described in more detail below with reference to the appended Figures.

### BRIEF DESCRIPTION OF THE DRAWINGS

FIG. 1 is a block diagram of a system, according to an exemplary embodiment of the present invention.

FIG. 2 is an isometric view illustrating a device in a “folded” position, according to an exemplary embodiment of the present invention.

FIGS. 3, 4, and 5 are side views (FIGS. 3 and 5) and an isometric view (FIG. 4) illustrating the device shown in FIG. 2 with a discharge boom in three different positions.

FIG. 6 is an isometric view illustrating an auger apparatus, according to an exemplary embodiment of the present invention.

FIG. 7 is an isometric view illustrating an auger blade of the auger apparatus shown in FIG. 6.

FIG. 8 is an isometric view illustrating a “folded” embodiment of a device having an auger apparatus, according to an exemplary embodiment of the present invention.

FIGS. 9, 10, and 11 are isometric views (FIGS. 9 and 11) and a side view (FIG. 10) illustrating the device shown in FIG. 8 with a boom in three different positions.

FIG. 12 is a bottom isometric view illustrating a hydraulic submersible jetting pump, according to an exemplary embodiment of the present invention.

FIG. 13 is a top isometric view of the hydraulic submersible jetting pump shown in FIG. 12.

FIGS. 14, 15, and 16 are side views (FIGS. 15 and 16) and an isometric view (FIG. 14) illustrating a device with a pump apparatus, according to exemplary embodiments of the present invention.

FIGS. 17 and 18 illustrate two isometric views of a shoveling excavation attachment, according to an example embodiment of the present invention.

FIGS. 19, 20, and 21 are side views (FIGS. 20 and 21) and an isometric view (FIG. 19) illustrating the shoveling attachment shown in FIGS. 17 and 18 connected to a device, according to exemplary embodiment of the present invention.

FIG. 22 illustrates a system according to an exemplary embodiment of the present invention.

FIG. 23 illustrates a system according to an exemplary embodiment of the present invention.

FIG. 24 is a side elevation view illustrating a device, according to an exemplary embodiment of the present invention.

FIG. 25 is a side elevation view illustrating a device, according to an exemplary embodiment of the present invention.

FIG. 26 is a side view illustrating a device, according to an exemplary embodiment of the present invention.

### DETAILED DESCRIPTION

Like reference characters denote like parts in the several drawings.

Example embodiments of the present invention include a remotely-operated tracking device that provides a large variety of vessel cleaning implementations and effectively accomplishes many dangerous tasks that humans are currently often required to perform. For example, embodiments of the present invention provide for the performance of the following tasks: directional fluid jetting, directional chemical injection, steam injection, centrifugal pumping, screw conveyance, hydro-excavation, pneumatic and fluid eduction, and vacuuming.

Not only can the above tasks be accomplished in a safe manner, but they may be effectively and efficiently performed simultaneously or consecutively with a single operator. To facilitate effective and efficient services, in accordance with an exemplary embodiment of the present invention, a cleaning device may be equipped with industrial “quick” fittings so that implements may be removed and changed quickly and easily with minimum to no tooling. Additionally, according to exemplary embodiments of the present invention, the cleaning device may be configured to change its shape such it can enter a tank or vessel through an opening with minimal space. For example, accordingly to an exemplary embodiment of the present invention, a device may be provided that folds into itself such that its largest dimensions allow it to enter a cylindrical access hole with a diameter of about 17.75 inches. Further, according to example embodiments of the present invention, the device may be driven with electric over hydraulic directional control valves. In example embodiments, the hydraulic directional control valve used may support up to 30 gallons per minute at 5000 pounds per square inch, which is the equivalent of about 87.515 horse power. However, other drive sources can be used, such as pneumatics, electronics, hydraulic over hydraulic, or pneumatics over hydraulics, or any applicable combination thereof. The unique device and system configuration, along with the novel tools/attachments discussed herein, provide for a high power, compact and effective cleaning device and system.

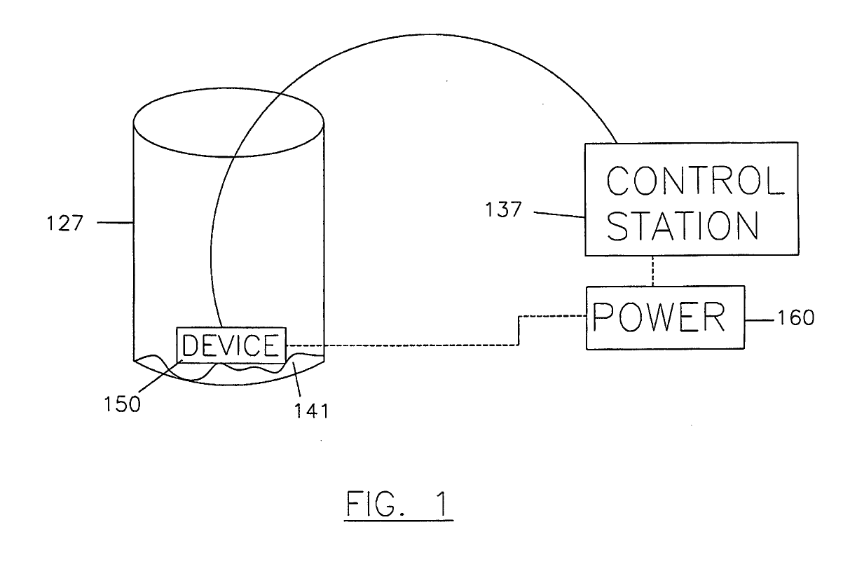

FIG. 1 illustrates an exemplary embodiment of a system 100 for cleaning a vessel. A cleaning device 150 is remotely controlled by an operator at the control station 137, external to the vessel 127. The control station 137 is operatively connected to the cleaning device 150 and transmits signals to the device 150, based on the operator's input at the control station 137. A display device is provided at the control station 137, wherein the operator can monitor the device 150 inside of the vessel and make any necessary adjustments to the system.

The control station 137 and device 150 are operatively connected to a power source 160 to provide power for the system 100. According to example embodiments, the device 150 is driven with electric over hydraulic directional control valves. However, other drive sources can be used, such as pneumatics, electronics, hydraulic over hydraulic, or pneumatics over hydraulics, or any applicable combination thereof.

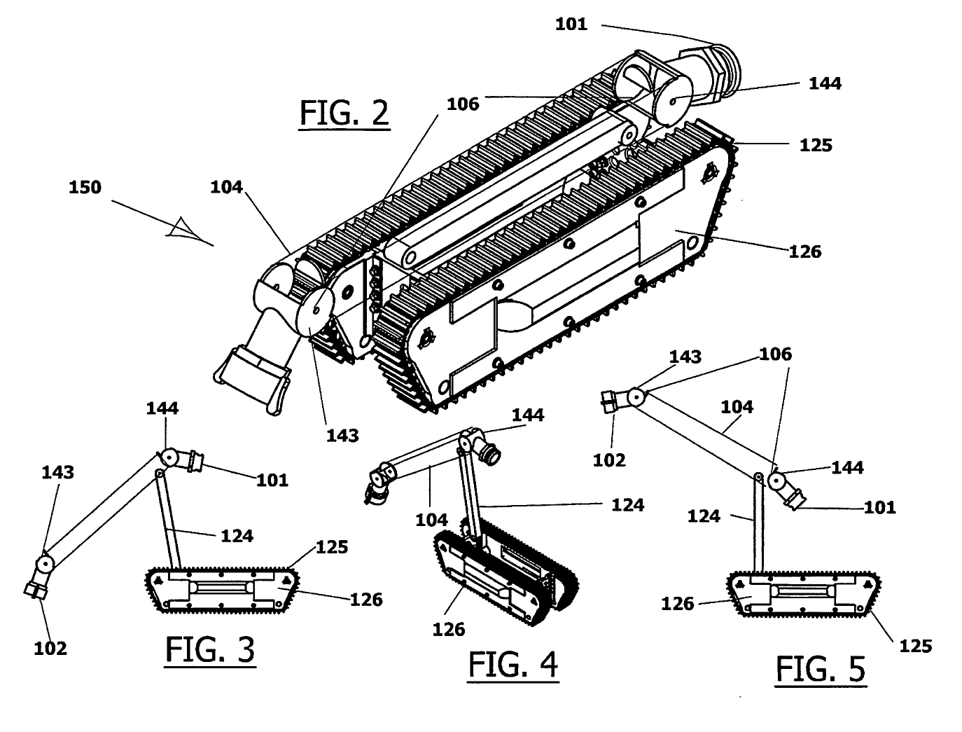

FIG. 2 illustrates cleaning device 150 according to an exemplary embodiment of the present invention. Cleaning device 150 includes a chassis 126, extension arm 124, and a vacuum/discharge boom 104. The extension arm 124 is connected to the top of the chassis 126, and the boom 104 is pivotally connected to the extension arm 124. Pivotally connected to the suction end of the boom 104 is a female connector 102 utilizing sealed live swivel pivot joints 106, and pivotally connected to the discharge end of the boom 104 is a quick connect fitting 101, utilizing sealed live swivel pivot joints 106, which, in certain embodiments, connects to a flexible hose for discharging the solids, fluids, or sludge collected by the boom 104. The pivot joints 106, in certain embodiments, are sealed by covering them with rugged rubber bellows. These bellows allow the swivels to pivot about 80 degrees of a 360 degree rotation and maintain an adequate seal for pumping and vacuuming materials. Keeping the flow profile as linear as possible allows for the most compact size and maximizes the efficiency of the chosen material transfer method. When size and efficiency is not an issue, in example embodiments, the pivotal joints 106 may be replaced with offset swivels, such as CHICKSAN®, to allow for a greater range of motion.

In further example embodiments, the boom 104 is a sealed, articulating, hollow arm, by which solids, fluids, slurries, and sludge products may be pumped or vacuumed directly through the center of the boom 104. The boom 104 serves as the connecting point by which attachments may be connected to the device 150, depending on the particular application, utilizing the female connector 102. In example embodiments, hydraulic motors (hydraulic rams and cylinders) are used to power the boom 104. The range of motion of the boom 104 varies, depending upon the length and placement of the motor's rams, but by way of example, the boom 104 may articulate as illustrated in FIGS. 2 through 5. The rams are generally hydraulic, but pneumatics, electric, and water driven cylinders may be alternatively used. Furthermore, servo or gerotor motors may replace hydraulic motors to increase the range of motion beyond linear motion constraints. In still further example embodiments, other forms of mechanical linkage can be used to maximize maneuverability.

The boom 104 may be utilized in the same manner as the center section of an excavator. The boom 104 can carry, dig, swivel, lift, and drag. Additionally, the vacuum inlet 143 located directly at the end of the suction side of the boom 104 provides that the boom 104 requires less range of motion while excavating materials.

The discharge end 144 of the boom 104 may be equipped with a male cam-lock 101 to match recognized industry standards, but other connections may be used as directed by customer, application, and/or safety requirements.

The suction end 143 in example embodiments of the boom 104 has a rotating rugged quick connect fitting 102 that directs spray and suction direction. Furthermore, this pivotal quick connection 102 also provides the ability to rapidly change from one implement to another with minimal down time and job delays. This beneficial design allows the operator to effectively engage, and quickly adapt to an unpredicted situation that often occurs when cleaning a tank or vessel.

Furthermore, the articulating maneuverability of the boom 104 allows the operator to reach beyond, above, and/or behind most obstructions that are commonly found inside tanks or vessels. Utilizing this capability allows the user to strategically place the device 150 in an effective working position.

The device 150 may be stationary or movable. The chassis 126 need not necessarily have any movement elements. However, in certain embodiments, movement of the device 150 across the floor of the vessel may be accomplished via endless tracks 125. In other embodiments, movement of the device may be achieved by wheels, rollers, treads, or any other suitable means for moving the device. Device 150 may also be controlled through hard or wireless communications.

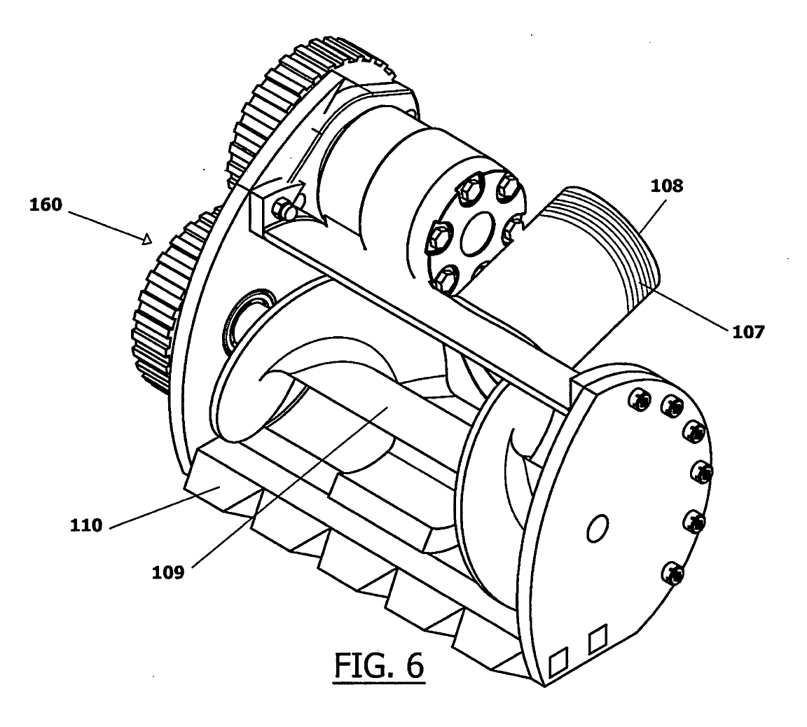

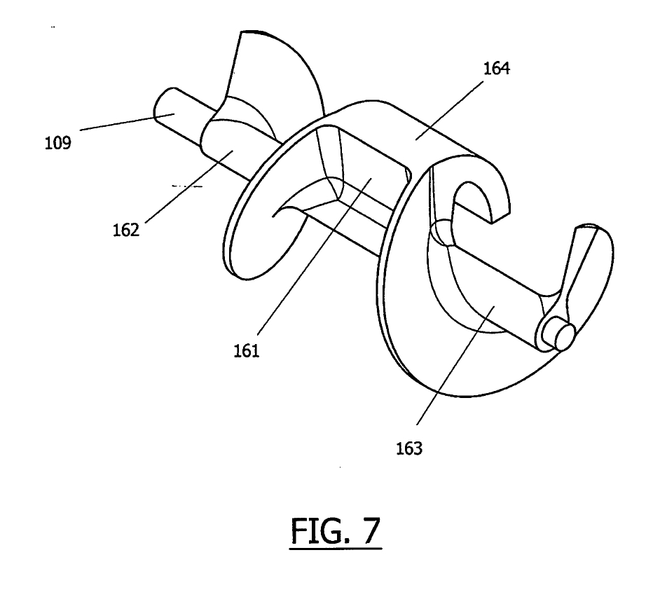

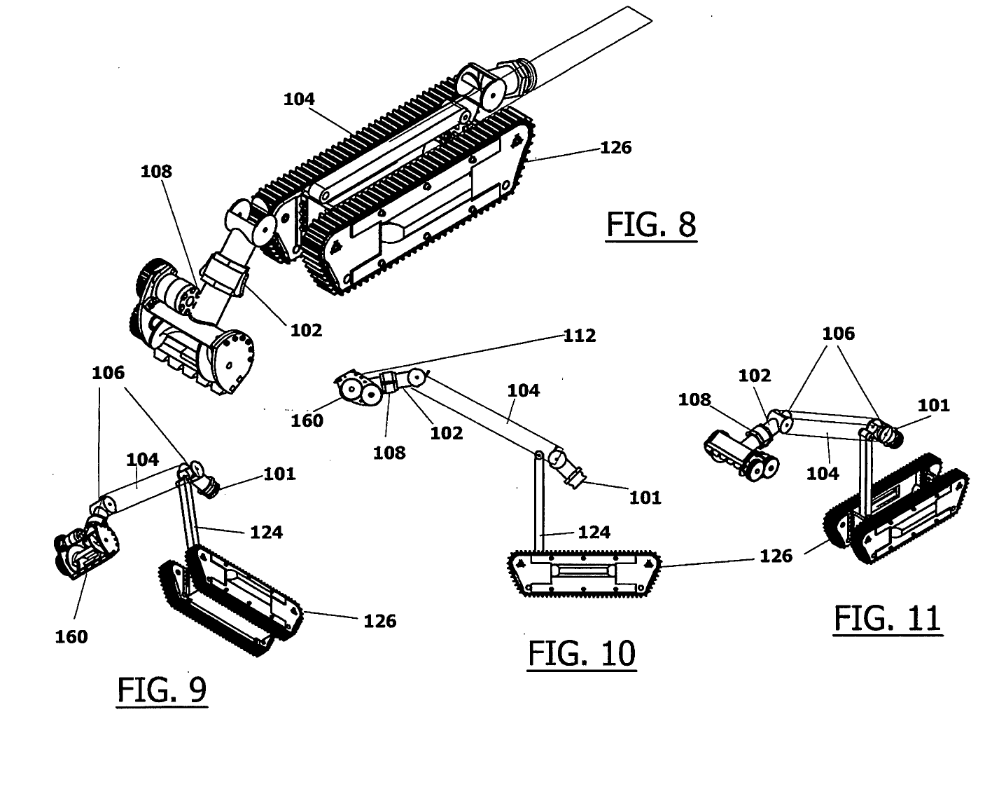

FIGS. 6 through 11 illustrate an auger attachment 160, which, in desired applications, may be connected to the female connector 102 of the device 150 at its vacuum discharge orifice 108. The auger blade 109 utilizes left and right handed flightings 162 and 163 to convey product towards a central paddle 161 that propels the product in the direction of the discharge outlet. The auger attachment 160 is most commonly used in conjunction with a vacuum. The auger 160 is additionally equipped with an orifice limiter/shutter 164 that passes in front of the discharge outlet once per revolution. The orifice limiter 164 momentarily causes an increase in vacuum velocity; this momentary increase in velocity creates an enhanced effect on the performance of the vacuum by preventing the hose column to fill as rapidly. The direct effects of not allowing the hose column to fill rapidly is that the horizontal and vertical vacuum ability is increased. The orifice limiter/shutter 164 may be provided in various configurations (for example larger or smaller blocking surface areas and/or open area configurations) to effectively block the discharge outlet for shorter and longer periods of time thereby by directly effecting the vacuums suction and allowing for slugs of material to removed without filling the hose column.

To maximize functionality, the auger attachment 160 may be inverted 180 degrees to create a rotary scraping tool, as shown in FIGS. 10 and 11, utilizing its removable teeth 110. In this manner, the auger 160 may work as a rake to strip down large piles of material. The auger 160 may be used when attempting to remove heavy, settled product that does not flow freely.

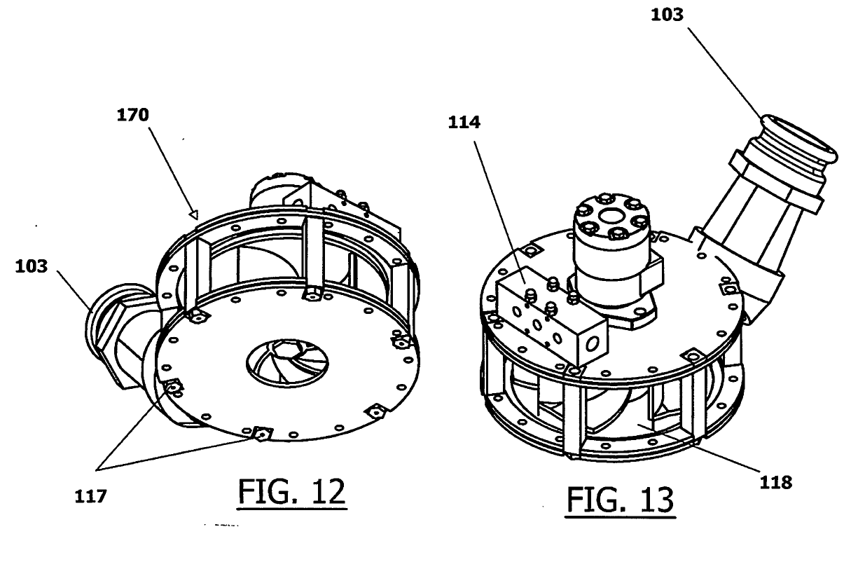

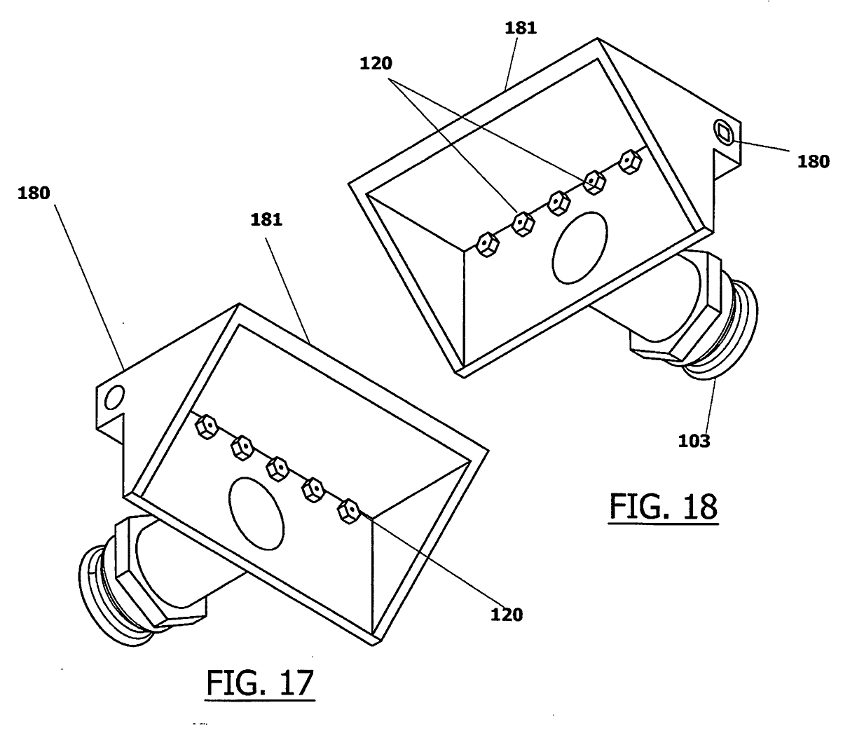

FIGS. 12 through 16 illustrate a hydraulic submersible jetting pump 170 which may be attached to the boom's female connector 102 utilizing the pump's male quick connector 103, which may be used to perform vacuum excavation (also referred to as hydro excavation). This process significantly reduces the risk of loss of property and injury to workers associated with contacting or cutting underground utilities, as often happens if backhoe, auger, hand digging, or other mechanical methods are used. Typically, vacuum excavation loosens the soil with a blunt-nosed high pressure air lance or water source and immediately vacuums away loosened material. When used appropriately, air and water are far less likely than sharp-edged tools to damage structures.

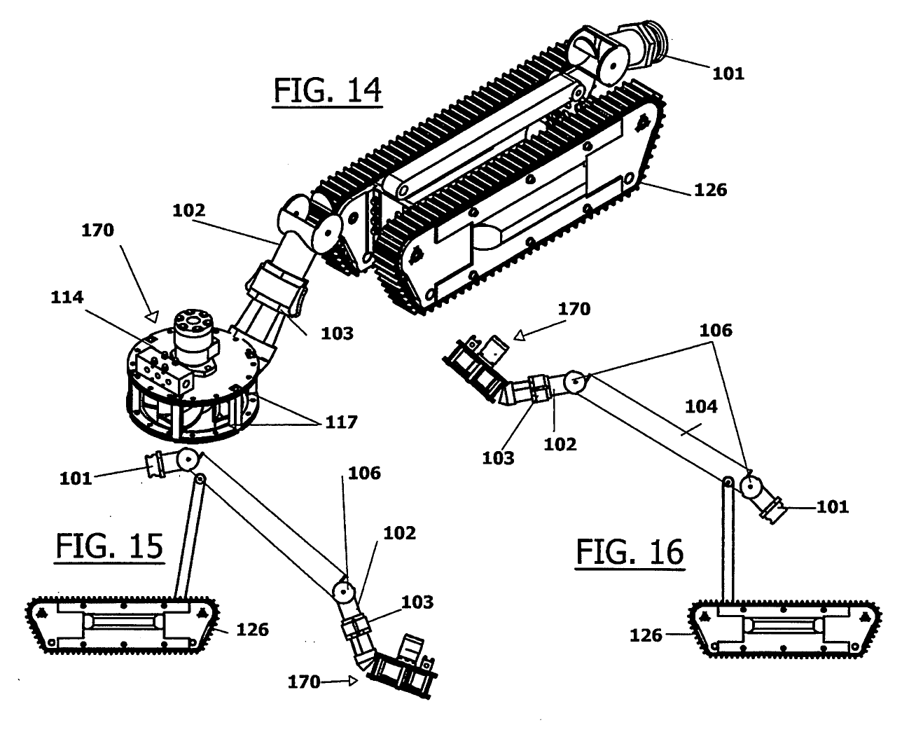

As shown in FIGS. 14 through 16 vacuum boom 104 may be provided as just a hollow boom, i.e., without a vacuum during operation of pump 170. That is, boom 104, may be essentially a conduit for materials being pumped out of a vessel. Alternatively, a vacuum may be applied during operation of pump 170 such that boom 104 acts as a vacuum boom. The utilization of various configurations of a vacuum with a pumping action may be controlled by an operator and adapted to the application at hand.

The hydraulic submersible jetting pump 170, in example embodiments, is driven by a compact hydraulic gerotor motor. The jet ring surrounding the pump 170 may be pressurized with an external pump such as triplex pumps, diaphragm pumps, multi and single stage centrifugal pumps, plunger pumps, and the like. The nozzles 117 attached to the pump 170 assist with suspending material and placing it into a pumpable state.

The pump 170 has a curved and tapered pump impeller 118. The pump 170 is equipped with a high pressure fluid supply through its high pressure fluid injection manifold 114. The pump size and style selected to pressurize the fluid is determined based on the necessary flow and pressure needed to best complement the nozzles 117 and the fluid that is passing through the pump 170.

The nozzles 117 located at the end of the pump 170 can be placed in several configurations that allow the operator to not only fluidize and agitate product, but also blast surfaces with pressurized fluid. For instance, with approximately 9 degrees of pitch and 12 inches of separation between the nozzles 117, the streams of both will meet approximately 36 inches from the middle of the pump 170. The nozzles 117 may also be place in a swirling configuration facing slightly toward the center of the pump 170 and creating a vortex affect that swirls in the same direction of the impeller 118 vortex.

The nozzles 117 of each implement are selected based upon the scope of work at hand. The configuration or placement of the nozzles 117 is chosen to best compliment the implementation that is being used. The nozzles 117 are often threaded in a fixed location, but in other example embodiments, rotating and 360 degree nozzles may be utilized. The fluid is fed to the nozzles 117 via a hose connected to an external pump (not shown). The fluid used in example embodiments may come from an external reservoir, and is pressurized with the use of the external pumps. The pump size and style selected to pressurize the fluid will often vary according to the scope of work at hand. In certain example embodiments, the same fluid that is removed from the tank is captured and re-circulated through the pump as a closed loop system so that no new fluid is added during the cleaning process.

In other example embodiments, the hydraulic submersible pump is utilized to quickly remove heavy, freely flowing product.

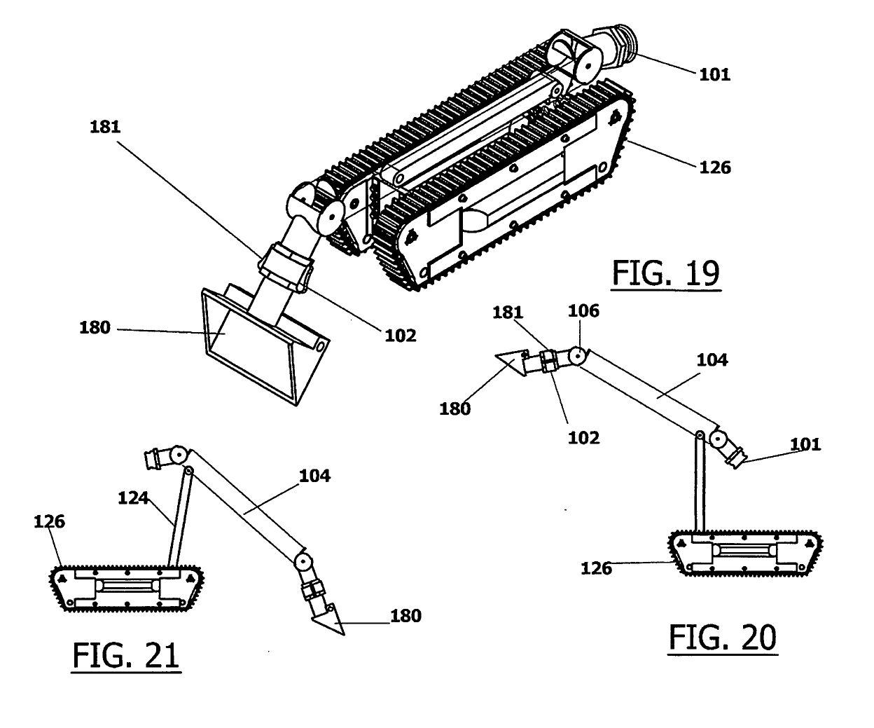

FIGS. 17 through 21 illustrate a shoveling tool attachment 180 that may be utilized in several ways. For example, it may be provided to perform hydro excavation. This implement allows the user to directionally blast and break up heavy, for example, cement-like product, utilizing the directional jetting and washing nozzles 120. The bucket shape of the shoveling tool 180 may be used in combination with the direct force of the boom 104 to dig, scrape, and push. The shoveling tool 180 may also be inverted 180 degrees and used as a funnel that directs the material towards the vacuum. Often times a tank or vessel must be squeegeed clean; in this instance a flexible edge 181 is placed upon the end of the spade and used to scrape and/or squeegee as the vacuum excavates the material.

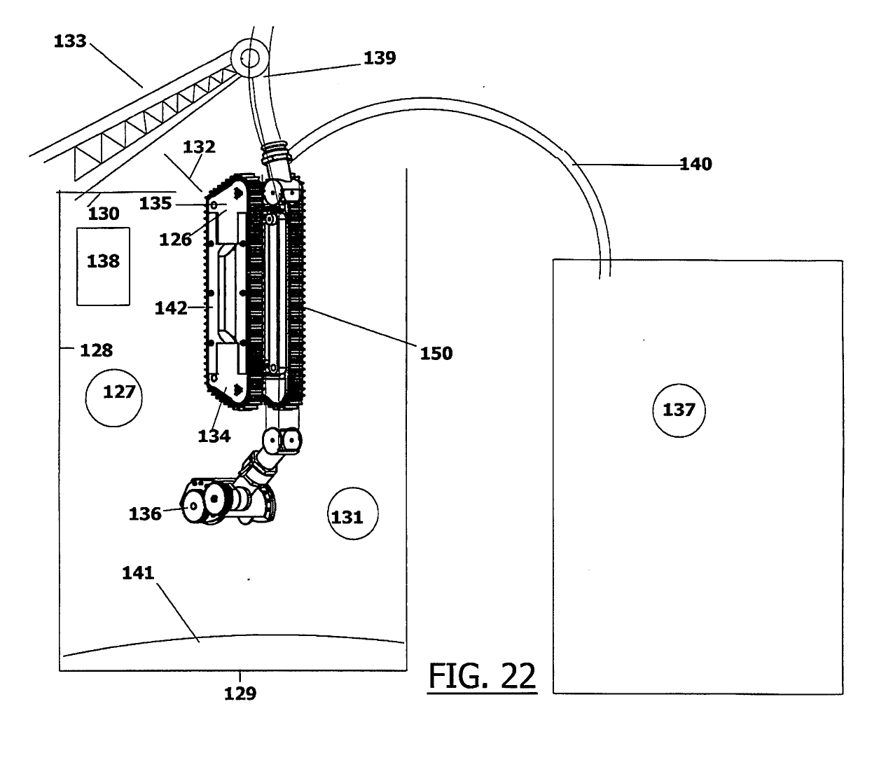

FIG. 22 illustrates a control station 137 that is preferably provided external to vessel 127. Control station 137 includes such suitable control technologies for remotely controlling, including but not limited to, the movement of one or more of the following: the chassis 126, boom 104, extension arm 124, and attachment 136. In some embodiments, the device 150 is hydraulically controlled. In other embodiments, control station 137 may include a programmable logic controller (PLC) configured to deliver control signals to device 150 to control the movement of any movable components of device 150 (such as endless tracks 125). Accordingly, such PLC or other suitable controller may be configured to convert user inputs into control signals for operating any movable component of device 150. User input signals may be provided from any suitable user interface device, such as buttons, switches, joysticks, etc. Further, user input signals and control signals may be either digital or analog, and the PLC or other suitable controller may be configured to accept and/or output either. In some embodiments, control station 137 further includes a monitor configured to display video from a camera 138 mounted in the tank interior 131, thereby allowing a user to view the movements of device 150. According to an exemplary embodiment, an umbilical cord 140 is provided for communicating between control station 137 and device 150. In other embodiments, communication may be established between control station 137 and device 150 via a wireless connection, such as RF, infrared, or any other suitable communication technology.

According to exemplary embodiments of the present invention, arm 124 and boom 104 can fold into the chassis 126, making the device 150 narrow enough to fit into an access hatch 132 with a diameter of about 17.75 inches or more without having to disassemble and reassemble the device 150. This feature allows for easy switchouts of the attachments 136 when new conditions are discovered inside the vessel 127. A lifting device 133, such as a hoist or a crane, may be used to place the device 150 into the vessel 127 and remove the device 150 from the vessel 127.

While each of the attachments described above have been shown as being attached to the device individually, it is understood that multiple attachments may be provided simultaneously in a single boom or in multiple booms on one device.

An example embodiment of a method of removing material from a vessel interior is also provided. The method includes folding a device 150 so that the arm 104 and boom 106 are folded into the chassis 126, e.g., as shown in FIG. 2. Further, the method includes attaching a hose 139 to the fitting 101. Next, the method includes placing a device in a vessel 128 by inserting the device 150 through an opening 132 in the vessel 128, as shown in FIG. 22. Next, the method includes manipulating a device 150 to traverse the vessel interior 131, by providing signals to the device 150 from the control station 137, through an umbilical cord 140 attaching the control station 137 to the device 150. Next, the method includes positioning a device 150 near the material 141 to be removed and applying a suction force from a boom 104 to the materials 141, such that the materials are moved from the vessel interior 131 into the boom 104, and exit the vessel 128 through the attached hose 139.

According to another embodiment of the present invention, a method and apparatus are provided for mechanical removal of material (including settled solids, fluids and slurries) from a tank or vessel. The apparatus may include a movable chassis having a front end portion and a rear end portion, a vacuum apparatus having an intake and a discharge, and an articulating boom. In some embodiments the movable chassis may further include treads, wheels, or other device suitable for allowing movement of the chassis across the floor of the tank or vessel. The vacuum intake may be located at the front end portion of the chassis, and the discharge may be located at the rear end portion of the chassis. In certain embodiments, said apparatus may further include a flow line connected to the discharge and configured to allow for the flow of materials to a location outside of the tank or vessel. The articulating boom may be attached to the chassis such that the boom may be rotated 360 degrees in a horizontal plane. The horizontal boom may be subdivided into two or more subsections joined by movable joints, each joint configured to allow for movement in: a vertical plane (up/down), a horizontal plane (side-to-side), or a rotational configuration (similar to a ball-and-socket joint). Finally, the articulating boom may include, at an end opposite the connection to the chassis, a tool configured to dislodge, break, or move settled material. The apparatus described in this paragraph, and/or features thereof, may be incorporated into the other exemplary embodiments described herein.

According to an alternative embodiment, a method for removing settled solids from within a tank or vessel may include the steps of: introducing an apparatus as set forth above into the tank or vessel via an opening or entry hatch; moving the apparatus to an area internal to the tank or vessel where settled solids have accumulated, mechanically dislodging the settled materials from the tank or vessel interior via the articulating boom and/or the attached tool; using the articulating boom and/or the attached tool to move the dislodged material near the intake; vacuuming the dislodged material into the intake; transporting the dislodged material out of the tank or vessel through the discharge and flow line. A control station may be provided whereby an operator can control the movements of the apparatus. Accordingly, in some embodiments, the method may further include providing a camera or other such video/viewing device in the tank interior such that the operator can view the movements of the apparatus via the control station. In low light environments, said camera may be an infra-red video camera or other such device capable of providing visual information in low or no light. Alternatively, in some embodiments, the method may further include providing a light source, either on the tank interior or on the apparatus. Finally, in some embodiments, the apparatus may be introduced into the tank or vessel via an opening/hatchway with a suitable lifting device, such as a crane. The method and related apparatus described in this paragraph, and/or features thereof, may also be incorporated into the other exemplary embodiments described herein.

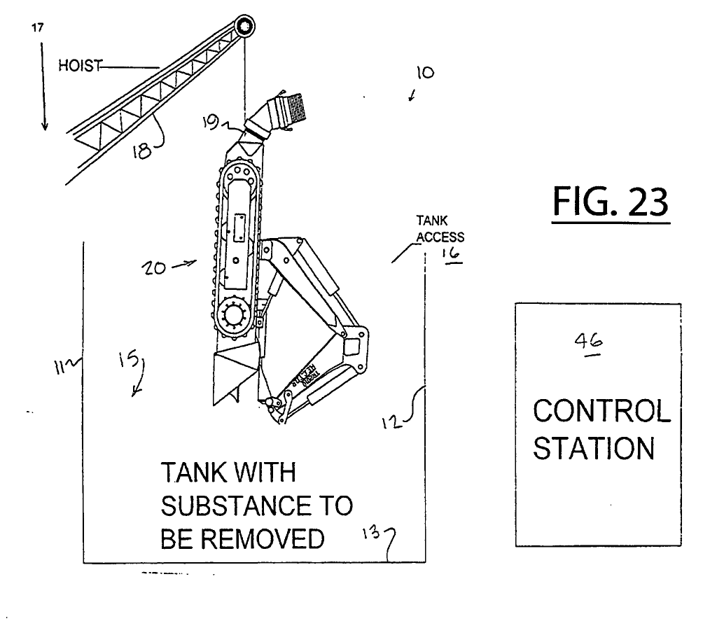

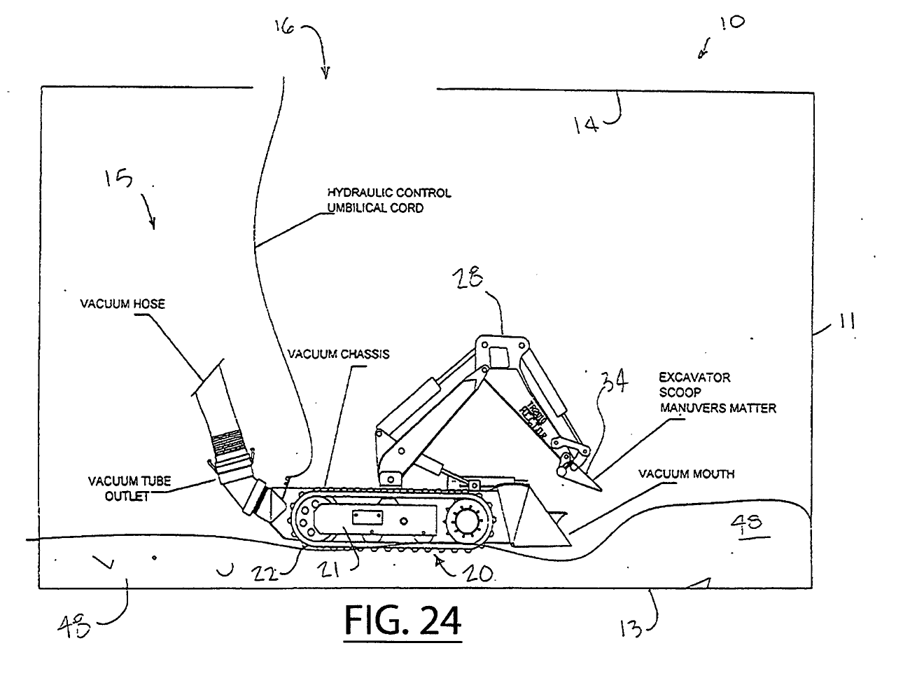

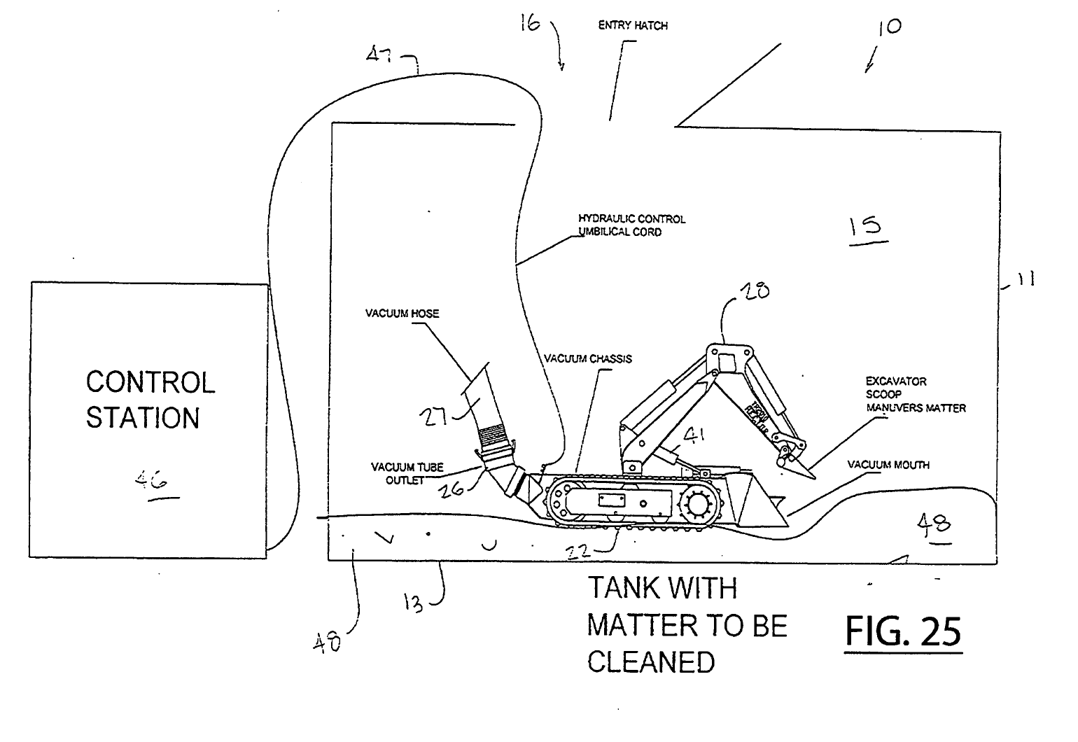

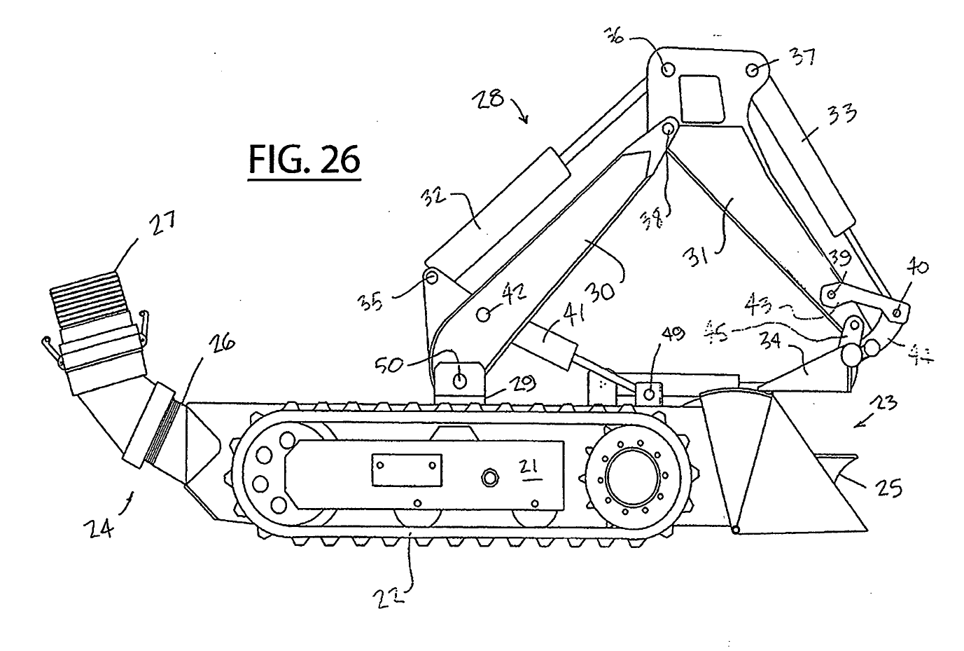

FIGS. 23 through 26 show schematic diagrams of an alternative embodiment, designated generally by the numeral 10. Tank cleaning system 10 is used to clean settled solids from a storage tank 11 or storage vessel 11. Such a tank or vessel 11 may contain a material 48 that has settled into solid and/or semi-solid matter, such as drilling mud. Tank 11 includes a side wall 12, bottom or bottom wall 13 and a top wall or roof 14. Interior 15 contains the settled material 48 to be removed. Tank 11 may further include an access opening or entry hatch 16 for gaining access to interior 15. In certain embodiments opening 16 may be a part of roof or top wall 14. A lifting device such as a hoist, crane, wheeled crane, mobile crane or any other such suitable device may be used to lift excavator 20. In certain embodiments, such a lifting device or crane 17 may provide boom 18, lifting lines and a lifting hook 19. Such a lifting device 17, boom 18, lifting line and hook 19 are known and commercially available.

According to an alternative embodiment, excavator 20 includes a movable chassis 21 having a front end portion 23 and a rear end portion 24, and a vacuum apparatus having an intake 25 and a discharge 26. Movement of excavator 20 may accomplished via endless tracks 22. In other embodiments, movement of excavator 20 may be achieved by wheels, rollers, treads, or any other such suitable device. Front end portion 23 is equipped with vacuum intake 25, and rear end portion 24 is equipped with vacuum discharge 26. A discharge hose or discharge flow line 27 is attached to vacuum discharge 26. The discharge hose or flow line 27 is long enough to transmit the suctioned or vacuumed settled solids 48 and convey them to a location outside of tank or vessel 11 for disposal.

In certain embodiments, an articulating boom 28 is provided on movable chassis 21. The articulating boom 28 may be attached to chassis 21 using a rotational connection 29. Accordingly, rotational connection 29 may be configured such that articulating boom 28 may be rotated 360 degrees in a horizon plane. Articulating boom 28 may further include multiple sections, such as boom sections 30 and 31 as illustrated in FIG. 4.

Articulating boom 28 may further include hydraulic cylinders 32 and 33 are for operating the boom sections 30, 31, according to an exemplary embodiment of the present invention. Each of hydraulic cylinder 32 and 33 may be configured to move boom sections 30 and 31 either up or down in a vertical plane. A tool, such as scoop 34, may be provided at an end portion of articulating boom 28 opposite the end portion connecting to rotation connection 29. While the tool illustrated in FIGS. 23 to 26 is a scoop 34, any other attachment suitable for dislodging, breaking, or moving settled material 48 may be included in other embodiments. Pivotal connections 35 to 40 are used for connecting the sections of the boom 30, 31 and the digging implement or a scoop 34. Links 43, 44, 45 are used to operate the digging implement or scoop 34. Cylinder 41 is pivotally attached to boom 28 at pivotal connection 42. Cylinder 41 is pivotally attached to chassis 21 at pivotal connection 49. Cylinder 41 can be used to raise or lower boom section 30, rotating same about pivot or pivotal connection 50.

A control station 46 is provided, preferably external to tank 11 interior 15. Control station 46 includes such suitable control technologies for remotely controlling, at a minimum, both the movement of movable chassis 21 and articulating boom 28. In some embodiments, excavator 20 is hydraulically controlled. In other embodiments, control station 36 may include a programmable logic controller (PLC) configured to deliver control signals to excavator 20 to control the movement of chassis 21, external boom 28, and any other movable components of excavator 20 (such as boom endless tracks 22, boom sections 30 and 31 and cylinders 32, 33, and 41). Accordingly, such PLC or other suitable controller may be configured to convert user inputs into control signals for operating any movable component of excavator 20. User input signals may be provided from any suitable user interface device, such as buttons, switches, joysticks, etc. Further, user input signals and control signals may be either digital or analog, and the PLC or other suitable controller may be configured to accept and/or output either. In some embodiments, control station 46 further includes a monitor configured to display video from a camera mounted in tank interior 15, thereby allowing a user to view the movements of excavator 20. According to an exemplary embodiment of the present invention, an umbilical cord 47 is provided for communicating between control station 46 and excavator 20. In other embodiments, communication may be established between control station 46 and excavator 20 via a wireless connection, such as RF, infrared, or any other suitable communication technology.

The foregoing embodiments are presented by way of example only. While the embodiments are described herein with reference to various implementations and exploitations, it will be understood that these embodiments are illustrative and that the scope of the invention(s) is not limited to them. In general, embodiments of a method and/or apparatus for removing material from storage tanks as described herein may be implemented using methods, facilities, and devices consistent with any appropriate structural or mechanical system(s). Many variations, modifications, additions, and improvements are possible and the various aspects of the different embodiment described herein may be incorporated into each of the different exemplary embodiments described as appropriate to accomplish to tasks specified herein.

For example, plural instances may be provided for components, operations or structures described herein as a single instance. Boundaries between various components, operations and functionality are depicted somewhat arbitrarily, and particular operations are illustrated within the context of specific illustrative configurations. Other allocations of functionality will also fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A device for removing material from a vessel, comprising: a chassis and a remotely controllable articulating assembly connected to the chassis, the assembly including an arm and a hollow boom, the arm having a first end pivotally connected to the chassis and a second end pivotally connected to the boom, the boom configured to act as a manueverable member of the assembly and at least one of a vacuum and a conduit for a working tool, wherein the device is configured to remove the material from an internal portion of the vessel.

2. The device of claim 1, wherein the working tool is a pump having a spray nozzle arrangement, wherein a first sealed pivotable joint and a second sealed pivotable joint are connected to a first end portion and a second end portion, respectively, of the boom, wherein a hose is connected to the first sealed pivotable joint and the pump is connected to the second sealed pivotable joint, the hose extending outside the vessel, wherein the spray nozzle arrangement has at least one nozzle configured to work in conjunction with at least one of the pump and the vacuum and configured to at least one of jet, agitate, and fluidize the material, wherein at least one of the pump and the vacuum is configured to remove the material from the vessel, wherein at least one of the chassis and the assembly are controlled remotely by an operator external to the vessel.

3. The device of claim 1, further comprising a control system operatively connected to the device and configured to control movement of at least one of the assembly and the chassis.

4. A device for removing material from a vessel, comprising: a chassis and a remotely controllable articulating vacuum assembly connected to the chassis, the vacuum assembly having at least two joints and configured to remove the material from an interior portion of the vessel.

5. The device of claim 4, wherein the vacuum assembly includes an arm having a first end pivotally connected to the chassis and a second end pivotally connected to a vacuum boom.

6. The device of claim 4, further comprising a control system operatively connected to the device and configured to control movement of at least one of the vacuum assembly and the chassis.

7. The device of claim 4, wherein the chassis includes a moving arrangement configured to traverse an interior surface of the vessel and is remotely controllable.

8. The device of claim 4, wherein the chassis is stationary.

9. The device of claim 5, wherein the boom has opposing ends, and the device further comprises a connector pivotally connected to one of the opposing ends of the boom.

10. The device of claim 5, wherein the boom has opposing ends, and the device further comprises a fitting pivotally connected to one of the opposing ends of the boom.

11. The device of claim 5; wherein the boom has a first end and a second end, and the device further comprises:
a connector and
a fitting;
wherein the connector is pivotally connected to the second end of the boom, and the fitting is pivotally connected to the first end of the boom.

12. The device of claim 11, further comprising a first sealed pivot joint connecting the connector to the second end of the boom and a second sealed pivot joint connecting the fitting to the first end of the boom.

13. The device of claim 11, further comprising a submergible centrifugal pump connected to the connector.

14. The device of claim 13, wherein the pump comprises a spray nozzle arrangement including at least one nozzle, wherein the nozzles are configured to work in conjunction with the vacuum assembly and configured to at least one of jet, agitate, and fluidize the material.

15. The device of claim 11, further comprising an auger connected to the connector.

16. The device of claim 15, wherein the auger includes a left flighting and a right flighting configured to push material toward the connector and the second end of the boom.

17. The device of claim 16, wherein the auger further comprises a shutter between the left flighting and the right flighting, wherein the shutter is configured to momentarily block the connector and the second end of the boom.

18. The device of claim 15, wherein the auger further includes teeth configured to rake and scrape the material.

19. The device of claim 11, further comprising a shoveling tool connected to the connector.

20. The device of claim 19, wherein the shoveling tool includes at least one directional nozzle configured to blast and break up the material.

21. The device of claim 20, wherein the shoveling tool further includes a flexible edge to scrape the material as the vacuum assembly excavates the material.

22. The device of claim 5, wherein the arm and the boom are configured to fold into the chassis.

23. The device of claim 11, wherein the arm and the boom are configured to fold into the chassis.

24. The device of claim 22, wherein the device is configured to fit into a hole of about 17.75 inches.

25. The device of claim 23, wherein the device is configured to fit into a hole of about 17.75 inches.

26. A method of removing material from a vessel interior, comprising the steps of:
folding a device into itself, the device including: a chassis; a vacuum assembly; and a hose, the vacuum assembly having an arm and a vacuum boom, the arm pivotally connected to the chassis and pivotally connected to the vacuum boom such that the arm and the boom fold together and proximate to the chassis, the hose attached to the vacuum assembly and extending outwardly of the vessel interior;
placing the device in a vessel;
manipulating the device inside the vessel interior;
positioning the device near the material to be removed;
applying a suction force from the vacuum assembly to the materials, such that the materials are moved from the vessel interior into the vacuum assembly; and
removing the materials from the vacuum assembly through the hose.

27. A system for removing material from a vessel interior, comprising:
a device including a chassis, a hose and a remotely controllable articulating vacuum assembly attached to the chassis, the vacuum assembly having at least two joints and configured to remove the material from an interior portion of the vessel, the hose attached to the vacuum assembly and extending outwardly of the vessel interior; and
a control station operatively connected to the device and configured to control movement of the device such that a user may control the movement of the device from the control station.
